(19) United States
(12) Patent Application Publication
(10) Pub. No.: US 2006/0087297 A1
(43) Pub. Date: Apr. 27, 2006

(54) Multi-mode multi-phase inductor-less DC/DC regulator

(76) Inventor: Qi Deng, Chandler, CA (US)

Correspondence Address: Qi Deng;Apt# 140, 1400 N. Alma School Rd., Chandler, AZ, 85224, US

(21) Appl. No.: 10/973,039

(22) Filed: Oct. 25, 2004

(51) Int. Cl. G05F 1/40

(52) U.S. Cl. 323/237

(57) ABSTRACT

A multi-mode multi-phase inductor-less DC/DC regulator is powered by a voltage source and produces an output to a load. It includes at least two modes of operation, and allows automatic switching among modes. Each mode includes a charging phase and a transfer phase. Mode selection and automatic mode switching determination are achieved by comparing derived voltages from the voltage source with internal voltage references. Mode selection and automatic mode switching actuation are achieved by selectively actuating some or all of no more than eight switching and regulation elements. Charging and transfer phases alternate and phase change is achieved by changing the configurations of some or all of the switching and regulation elements to charge and discharge no more than two external flying capacitors to provide a voltage at the output. This voltage is then fed back to a voltage regulation circuit to produce a regulated output voltage to the load.

### CROSS-REFERENCE TO RELATED APPLICATIONS

Not Applicable

### FEDERALLY SPONSORED RESEARCH OR DEVELOPMENT

Not Applicable

### SEQUENCE LISTING OR COMPUTER PROGRAM

Not Applicable

### BACKGROUND OF THE INVENTION

1. Field of the Invention

The present invention relates to inductor-less DC/DC regulators commonly known in the art as charge pumps or switched capacitors, and more particularly, to multi-mode multi-phase inductor-less DC/DC regulators.

2. Description of Related Art

An inductor-less DC/DC regulator, commonly known as a charge pump or a switched capacitor in the art, utilizes internal switching elements to switch at least one external capacitor, known in the art as a flying capacitor, between energy storage phase and energy transfer phase to achieve a desired output voltage. If a regulated output voltage is not needed, a charge pump is typically used to generate an output voltage that is higher than the input voltage applied to the circuit. Such an inductor-less DC/DC regulator is typically referred to as an unregulated charge pump in the art. If a regulated output voltage is desired, a charge pump with internal voltage regulation circuitry can generate an output voltage that is lower than the input voltage applied to the circuit. Such an inductor-less DC/DC regulator is typically referred to as a regulated charge pump in the art.

A charge pump utilizes an internal timing device, known in the art as a clock or an oscillator, to generate a signal with alternating low high and logic low levels at a fixed frequency, known in the art as a clock signal. A pair of logic high and logic low is known in the art as a clock cycle, and the time duration of such a clock cycle, known in the art as period, is the inverse of the clock frequency. For example, if the frequency of a clock is 1,000,000 Hz, then the period of the clock cycle is 1/1,000,000 s, or 10⁻⁶ s, or 1 μs.

The fundamental operation of an unregulated charge pump is that, during the logic high phase of a clock cycle, the internal switching elements are positioned as such to allow the flying capacitor or flying capacitors to be charged by an external DC voltage, such as a battery, for the entire duration of the logic high phase of the clock cycle. This phase is referred to as the charging phase. During the logic low phase of the clock cycle, the internal switching elements are positioned as such to allow the fly capacitor or flying capacitors to transfer the charges accumulated during the charging phase to an external load for the entire duration of the logic low phase. This phase is referred to as the transfer phase.

The unregulated charge pumps are not desirable in electronic and electrical devices and instruments that require constant DC input voltage to operate. The regulated charge pumps are desirable for these electronic and electrical devices and instruments. The fundamental operation of a regulated charge pump that regulates output voltage is that, during the logic high phase of a clock cycle, the internal switching elements are positioned as such to allow the flying capacitor or flying capacitors to be charged by an external DC voltage, such as a battery. The duration of the actual charging is determined by the output voltage of charge pump. If a predetermined fraction of the output voltage exceeds a predetermined threshold voltage intrinsic to the charge pump prior to the completion of the logic high phase of the clock cycle, the charging can be interrupted by the means of opening a specific internal switching element on the charging current path, while the positions of all the other switching elements stay unchanged before the expiration of the logic high phase of the clock cycle. This phase is referred to as the charging phase. During the logic low phase of the clock cycle, the internal switching elements are positioned as such to allow the fly capacitor or flying capacitors to transfer the charges accumulated during the charging phase to an external load for the entire duration of the logic low phase. This phase is referred to as the transfer phase. Hence, a charge pump is frequently referred to as a multi-phase charge pump.

Many electronic and electrical devices and instruments that utilize charge pumps these days are portable and battery powered. A typical battery, with an output voltage denoted as V_{BATT}, has an operating voltage range. When the battery is fully charged, V_{BATT} is at the higher boundary of the operating voltage range. During its usage, V_{BATT} moves nonlinearly towards the lower boundary of the operating voltage range. Within the operating voltage range of the battery, a typical regulated charge pump outputs a constant post-regulation voltage, denoted as V_{OUT}, to the load. When V_{BATT} reaches the lower boundary of the operation voltage range, the electronic or electrical device or instrument senses this condition and shuts down.

Either an unregulated charge pump or a regulated charge pump produces a pre-regulation output voltage that is a multiple of the input voltage to the charge pump. Such a multiple is commonly referred to as a mode. A multiple, and therefore a mode, can be fractional. For example, a 1.5× mode regulated charge pump means the pre-regulation output voltage of the charge pump is 1.5 times of that of the input voltage of the charge pump. The commonly found modes or multiples in today's charge pumps are 1×, 1.5×, and 2×. Typically, the input voltage to the charge pump, denoted as V_{IN}, is equivalent to V_{BATT}.

Because of the constant voltage level requirement for V_{OUT}, and the decreasing voltage level nature of V_{BATT}, it is not desirable for the regulated charge pump to have only one mode multiple from energy conversion efficiency standpoint. For example, a typical Li-Ion battery has a V_{BATT} operating voltage range between approximately 3.0V and approximately 4.2V. In a typical Li-Ion battery powered mobile electronics device, the desired V_{OUT} is approximately 3.3V. Assuming a 1.5× mode regulated charge pump, and a V_{BATT} at approximately 3.1V, at the beginning of the operation, the pre-regulation output voltage of the charge pump is approximately 1.5 times 3.1V, or 4.65V. With the desired V_{OUT} at approximately 3.3V, this gives a theoretical maximum charge pump efficiency of approximately 71%, or 3.3V/4.65V. Assuming later on the Li-Ion battery is charged to its full capacity, with V_{BATT} at approximately 4.2V, this time the pre-regulation output voltage of the charge pump is approximately 1.5 times 4.2V, or 6.3V. This gives a theoretical maximum charge pump efficiency of approximately 52%, or 3.3V/6.3V. This represents an approximately 19% loss of efficiency due to the specific V_{BATT} change.

To prevent such efficiency loss, an automatic mode switching capability intrinsic to the charge pump, driven by V_{BATT} change, is desirable. Using the same example specified in the above paragraph, this time a 1×/1.5× automatic mode switching regulated charge pump is assumed. At the beginning of the operation, the pre-regulation output voltage of the charge pump is still approximately 1.5 times 3.1V, or 4.65V, which still gives a theoretical maximum charge pump efficiency of approximately 71%, or 3.3V/4.65V. Later on the Li-Ion battery is charged to its full capacity, with V_{BATT} at approximately 4.2V. This time, since V_{BATT} is higher than the 3.3V V_{OUT}, the operation of the charge pump switches automatically from 1.5× mode to 1× mode, and the pre-regulation output voltage of the charge pump is approximately 1 times 4.2V, or 4.2V. This gives a theoretical maximum charge pump efficiency of approximately 79%, or 3.3V/4.2V. The automatic mode switching from 1.5× to 1×, triggered by the V_{BATT} change, increases the charge pump efficiency by approximately 8%. This simple example only illustrates automatic mode switching between 1× mode and 1.5× mode in a regulated charge pump. More sophisticated automatic mode switching scheme can switch among more than two modes, driven by V_{BATT} change and desired V_{OUT} level.

3. Description of Prior Art

U.S. Pat. No. 6,504,422B1, which issued on Jan. 7, 2003, and U.S. Pat. No. 6,794,926B2, which issued on Sep. 21, 2004, both to William E. Rader, et al., and assigned to Semtech Corporation, propose a charge pump power supply including two or more modes or operation. This prior art provides a switching circuit containing ten switching elements S1-S10, or switches, and is illustrated by FIG. 4. The opening and closing of these switches dictate the charging current flow from a regulated intermediate voltage source V_{IN} to two flying capacitors 18 and 20, and transfer current flow from these flying capacitors to a load, thus enable the mode switching among 1×, 1.5×, 2×, and 3× modes. The same prior art also provides a voltage regulation circuit, illustrated by FIG. 5, in which an additional switching element 54 is used between a battery voltage V_{BATT} and the regulated intermediate voltage V_{IN}, which is in turn used to provide input voltage to the switching circuit in FIG. 4. Thus, in order to switch among operation modes and regulate V_{OUT}, the prior art uses eleven switching elements in total, three more than necessary as it will be explained in detail in the present invention.

Also, although the same prior art claims that a 3× mode is achievable, it is not practical by using only two external flying capacitors 18 and 20 and one external output capacitor 22 as illustrated by FIG. 4. While in theory V_{OUT} can be a 3× multiple of V_{IN}, in practice, as it is well known in the art, in order to accommodate an actually load, an additional flying capacitor is needed.

Further more, the same prior art provides a block diagram of a switching control circuit, as illustrated in FIG. 6, which includes a mode select block 30, a phase generator block 32, a switch control block 38. However, practical implementation circuits were not given for these blocks.

### BRIEF SUMMARY OF THE INVENTION

The present invention relates to an inductor-less DC/DC regulator commonly known in the art as charge pump or switched capacitor. It provides a complete and practical regulated multi-mode multi-phase inductor-less DC/DC regulator design, which was not provided by the cited prior art described in detail in U.S. Pat. No. 6,504,422B1 and U.S. Pat. No 6,794,926B2. The design comprises a resistor divider array, a voltage reference array, a switching control circuit, a switching and regulation circuit, and an output voltage. The design is illustrated in a set of detail circuit schematic diagrams in FIGS. 1-3.

The resistor divider array comprises three resistors in series, between the DC power source and a common zero volt reference voltage, commonly known in the art as ground. The outputs of the resistor divider array are two DC voltages above ground that go to the switching control circuit. The voltage reference array comprises two constant DC reference voltage sources, commonly known in the art as bandgap references, in series. The outputs of the voltage reference array are two constant DC voltages above ground that go to the switching control circuit and the switching and regulation circuit. The outputs of the resistor divider array are compared to the outputs of the voltage reference array in the switching control circuit. The switching control circuit comprises two comparators with hysteresis feature, a clock source, two latching devices commonly known in the art as D flip flops, and a plurality of logic gates and pass elements. The comparison between the output voltages from the resistor divider array and the output voltages from the voltage reference array is done by the comparators with hysteresis feature. The results of the comparisons determine the desirable operation mode for the regulated charge pump.

Once the desirable operation mode is determined, the clock source, the latching devices, and the logic gates and pass elements of the switching control circuit produce clocked switching control signals to the switching and regulation circuit. The switching and regulation circuit comprises a network of eight switching elements and two external charge storage capacitors, commonly known in the art as flying capacitors, and a voltage regulation circuit that also includes one of the eight switching elements. Thus, the present invention uses three fewer switching elements than the cited prior art described in detail in U.S. Pat. No. 6,504,422B1 and U.S. Pat. No 6,794,926B2. The switching elements are selectively actuated under the direction of the switch control signals to allow at least two different operation modes, each comprises at least two different phases. At least some of the switching elements change configurations when the phase changes to charge and discharge the external flying capacitors to provide a voltage at the output of the switching and regulation circuit. This voltage is then fed back to the voltage regulation circuit to enable the switching and regulation circuit to produce a regulated output voltage to the load.

### BRIEF DESCRIPTION OF THE DRAWINGS

FIG. 1 is an inductor-less DC/DC regulator circuit schematic diagram of one embodiment of the present invention.

FIGS. 2a-c are circuit schematic diagrams illustrating one embodiment of a switching control circuit of the inductor-less DC/DC regulator of FIG. 1.

FIG. 3 is a circuit schematic diagram illustrating one embodiment of a switching and regulation circuit of the inductor-less DC/DC regulator of FIG. 1.

FIG. 4 is a circuit diagram of a switching circuit of a prior art charge pump.

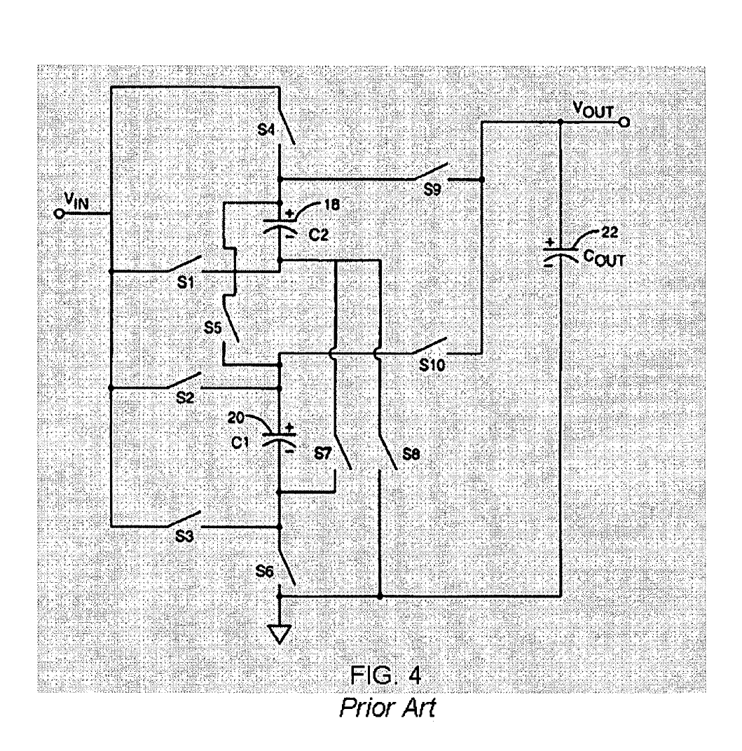

FIG. 5 is a circuit diagram of an input voltage regulator of a prior art charge pump.

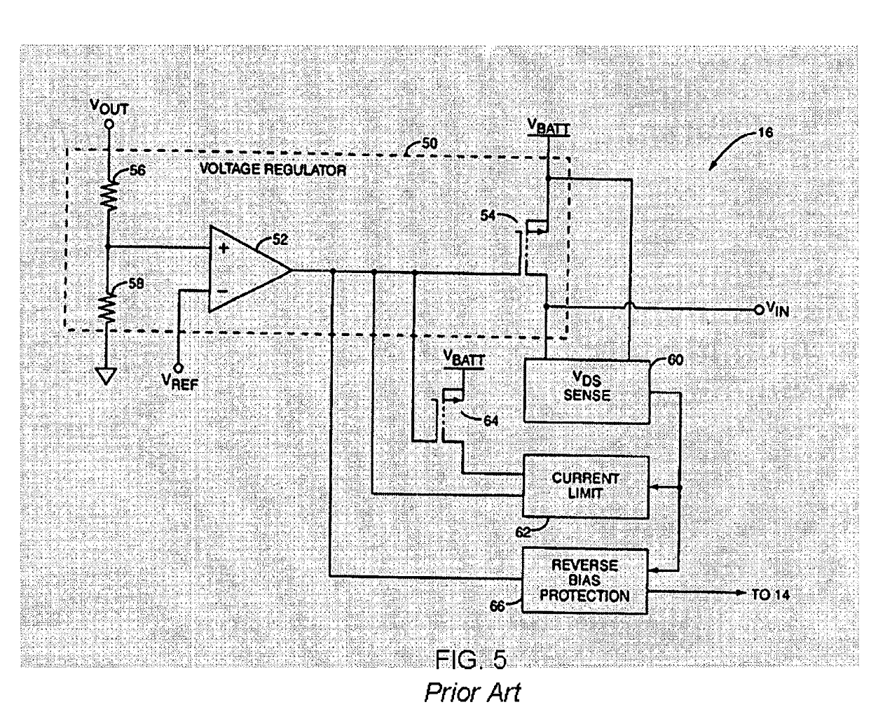

FIG. 6 is a block diagram of a control circuit of a prior art charge pump.

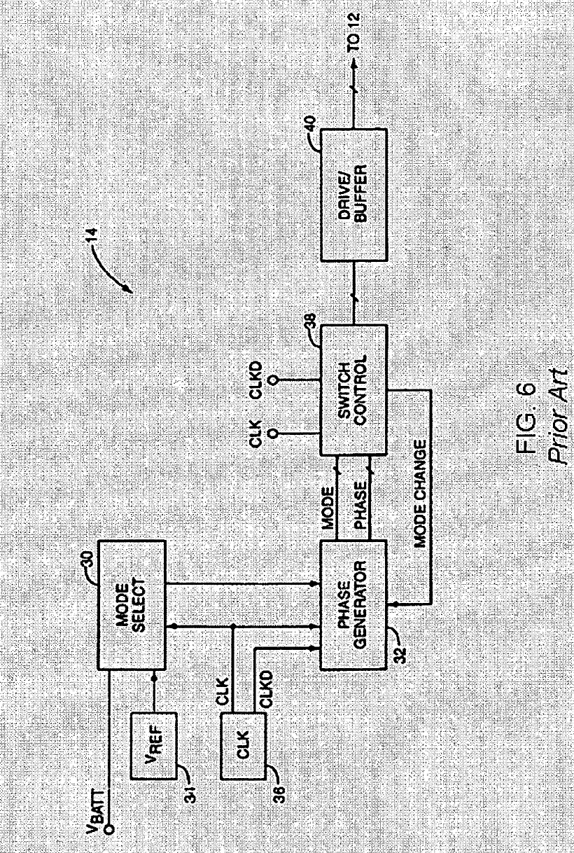

### DETAILED DESCRIPTION OF THE INVENTION

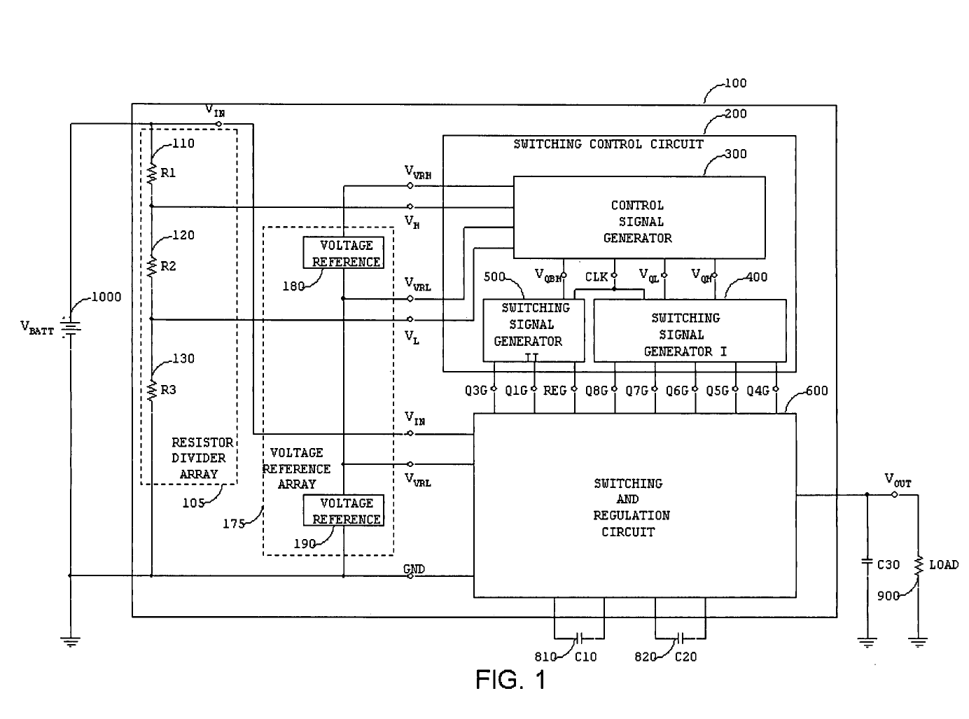

The present invention relates to an inductor-less DC/DC regulator commonly known in the art as charge pump or switched capacitor. A block diagram of an exemplary embodiment of an inductor-less DC/DC regulator, denoted generally by the numeral 100, is shown in FIG. 1. The inductor-less DC/DC regulator 100 is connected in series between a DC power source 1000, such as a battery, with a voltage level of V_{BATT}, and a load 900. The inductor-less DC/DC regulator provides a regulated constant DC output voltage, V_{OUT}, to the load 900.

In FIG. 1, the inductor-less DC/DC regulator 100 comprises a resistor divider array 105, a voltage reference array 175, a switching control circuit 200, and a switching and regulation circuit 600. The switching control circuit 200 comprises a control signal generator 300, a switching signal generator I 400, and a switching signal generator II 500. The level of the input voltage to the inductor-less DC/DC regulator 100, V_{IN}, is equivalent to V_{BATT}.

The mode in which the inductor-less DC/DC regulator 100 operates, after start up and during normal operation, is determined by the output voltage level, V_{BATT}, of the power source 1000, and the desired output voltage level, V_{OUT}, to the load 900.

The resistor divider array 105 comprises three resistors 110, 120, 130 in series, with resistance values of R1, R2, R3, respectively. This three resistor arrangement enables mode selection and automatic mode switching among 1×, 1.5×, and 2× modes. The resistor divider array 105 outputs two voltage levels denoted as V_{H} and V_{L}; V_{H} always has a higher voltage level than V_{L}. The values of R1, R2, and R3 are a function of V_{IN}. The following formulas give the values of V_{H} and V_{L}:
V_{H}=V_{IN}×(R2+R3)/(R1+R2+R3) 1)
V_{L}=V_{IN}×R3/(R1+R2+R3) 2)

The voltage reference array 175 comprises two constant DC voltage sources 190 and 180, commonly known as bandgap voltage references, in series. Each bandgap voltage reference has an intrinsic output voltage that is a constant DC value over a wide range of temperatures. The two bandgap voltage reference arrangement enables mode selection and automatic mode switching among 1×, 1.5×, and 2× modes. The output of the bandgap voltage reference 190 with reference to ground is its intrinsic output voltage value V_{VRL}. The output of the the bandgap voltage reference 180 with reference to ground is a combination of the intrinsic output voltage values of 190 and 180, and is a constant DC voltage with a value of V_{VRH}. V_{VRH} is always higher than V_{VRL} by the intrinsic output voltage value, V_{VRHI}, of the bandgap voltage reference 180. The values of V_{VRHI} and V_{VRL} are determined by V_{IN} and V_{OUT}.

After start up and during the normal operation of the inductor-less DC/DC regulator 100, the following conditions determine the desirable mode in which it operates:
1) If V_{L}<V_{VRL}, and V_{H}<V_{VRH}, the condition indicates a low V_{IN} with reference to V_{OUT}, and a 2× mode is desirable.
2) If V_{L}>V_{VRL}, and V_{H}<V_{VRH}, the condition indicates a medium V_{IN} with reference to V_{OUT}, and a 1.5× mode is desirable.
3) If V_{L}>V_{VRL}, and V_{H}>V_{VRH}, the condition indicates a high V_{IN} with reference to V_{OUT}, and a 1× mode is desirable.

The condition under which V_{L}<V_{VRL} and V_{H}>V_{VRH} does not occur if the values of R2, R3, V_{VRH}, and V_{VRL} are chosen as such: V_{VRHI}/V_{VRL}<1+R2/R3, or V_{VRHI}/ V_{VRL}<R2/R3, in which V_{VRHI} is the intrinsic output voltage value of the bandgap voltage reference 180.

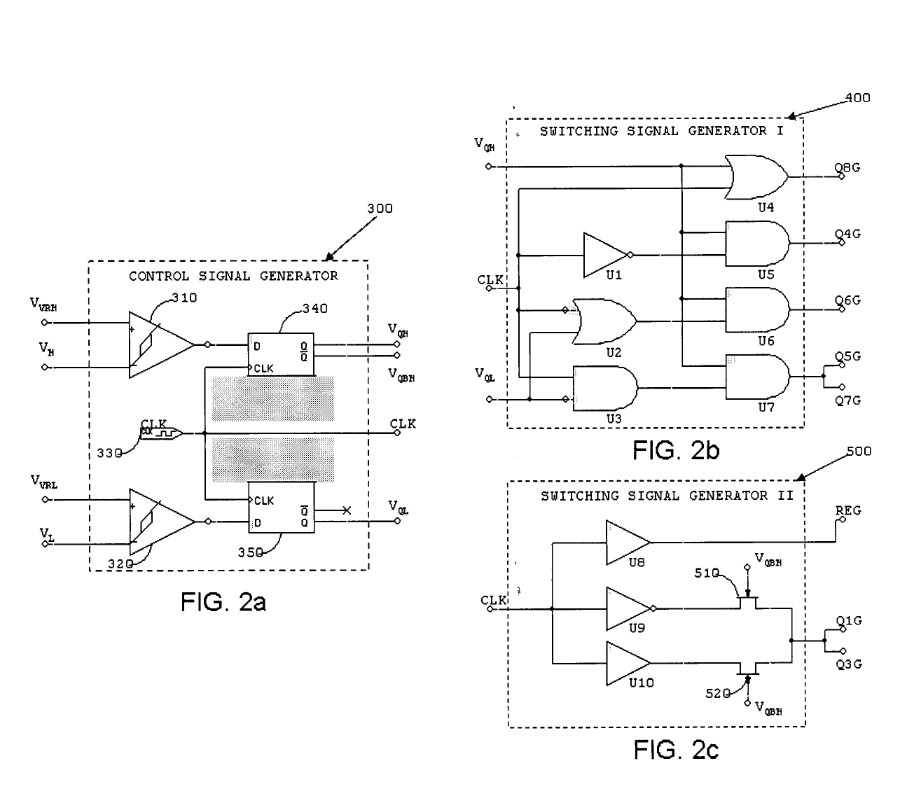

As shown in an exemplary embodiment of the control signal generator 300, illustrated in FIG. 2a, the actual comparison between V_{H} and V_{VRH} is performed by a comparator 310. The actual comparison between V_{L} and V_{VRL} is performed by a comparator 320. The comparators 310 and 320 have a built-in feature commonly known in the art as hysteresis. The hysteresis feature prevents a comparator from switching output by false or insignificant conditions such as a high voltage short burst on one of its inputs induced by an external noise source. The logic values of the outputs of the comparators 310 and 320, V_{CH} and V_{CL}, respectively, are given below:
1) V_{CH}=logic high, or H, and V_{CL}=H, which indicates that conditions of V_{L}<V_{VRL} and V_{H}<V_{VRH} have been detected by the comparators, and a 2× mode is desirable.
2) V_{CH}=H, V_{CL}=logic low, or L, which indicates that conditions of V_{L}>V_{VRL} and V_{H}<V_{VRH} have been detected, and a 1.5× mode is desirable.
3) V_{CH}=L, V_{CL}=L, which indicates that conditions of V_{L}>V_{VRL} and V_{H}>V_{VRH} have been detected, and a 1× mode is desirable.

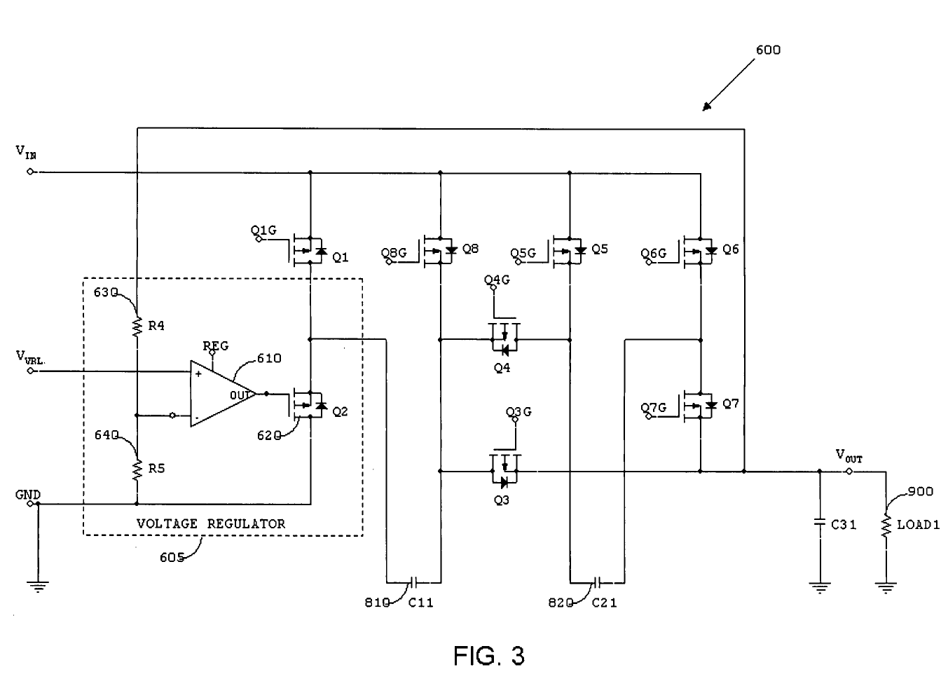

Thus, the desirable operation mode of the inductor-less DC/DC regulator 100 at any given time is controlled by the logic values of the outputs of the comparators 310 and 320, V_{CH} and V_{CL}, respectively, at that particular time. If, at a certain point of time during normal operation, the battery output voltage, V_{BATT}, changes in either direction and crosses a predetermined threshold voltage, the logic values of either V_{CH} or V_{CL}, or both, change as well, indicating an automatic mode switching is desirable at that particular point of time. The actually initial mode selection immediately after start up is accomplished by positioning the switching elements Q1-Q8 of a switching and regulation circuit 600 in FIG. 3 to configurations particular to the desirable mode. The actually automatic switching between modes during normal operation is accomplished by changing the switching elements Q1-Q8 from configurations particular to the current mode to configurations particular to the desirable mode. The mechanism of configuring the switching elements Q1-Q8 will be explained in more detail later.

There are two operation phases for the inductor-less DC/DC regulator 100, the charging phase and the transfer phase. The time durations of the charging and transfer phases and the automatic switching between charging and duration phases are controlled by a fixed frequency clock signal, CLK, generated by an internal clock source 330, illustrated in FIG. 2a. The charging phase happens during the logic high interval of a clock cycle. In charging phase, the switching elements Q1-Q8 of a switching and regulation circuit 600 in FIG. 3 are positioned in certain configurations to allow a charging current to flow into the flying capacitors 810 and 820 from the battery 1000. The transfer phase happens during the logic low interval of a clock cycle. In transfer phase, the switching elements Q1-Q8 are positioned in certain configurations to allow a transfer current to flow out of the flying capacitors 810 and 820 to the load 900. The automatic switching between the charging and transfer phases happens twice during one clock cycle. The mechanism of actuating the switching elements Q1-Q8 between phases will be explained in more detail later.

As shown in the control signal generator 300 in FIG. 2a, V_{CH} and V_{CL} further propagate into the D logic inputs of latching devices 340 and 350, commonly known in the art as D latches or D flip flops, respectively. The use of the D latches 340 and 350 is to couple the V_{CH} and V_{CL} with the output of an internal clock source 330 to produce clocked outputs V_{QH}, V_{QBH}, and V_{QL} to drive the subsequent logic gates U1-U7 of the switching signal generator I 400 in FIG. 2b, and logic gates U8-U10 and controlled passing elements 510 and 520 of the switching signal generator II 500 in FIG. 2c. The clock source 330 provides a fixed frequency clock signal, CLK, to the CLK inputs of the D flip flops 340 and 350. D flip flop 340 has two logic outputs, Q and /Q. The logic level of Q output, V_{QH}, follows that of V_{CH} with a delay of a clock cycle. The logic level of /Q output, V_{QBH}, is the logic inverse of that of V_{QH}. For example, when V_{QH} has a logic level of H, V_{QBH} has a logic level of L. D flip flop 350 has one logic output, Q. The logic level of Q output, V_{QL}, follows that of V_{CL} with a delay of a clock cycle. The logic levels of V_{QH}, V_{QBH}, and V_{QL}, are given as follows:
1) V_{QH}=H, V_{QBH}=L, and V_{QL}=H, all with 1 clock cycle delay, when a 2× mode is desirable, with V_{CH}=H and V_{CL}=H.
2) V_{QH}=H, V_{QBH}=L, and V_{QL}=L, all with 1 clock cycle delay, when a 1.5× mode is desirable, with V_{CH}=H, V_{CL}=L.
3) V_{QH}=L, V_{QBH}=H, and V_{QL}=L, all with 1 clock cycle delay, when a 1× mode is desirable, with V_{CH}=L, V_{CL}=L.

The clock signal CLK controls the duration of the charging and transfer phases, and the switching between the charging and transfer phases. The charging phase occurs during the logic high interval of a clock cycle, the transfer phase occurs during the logic low interval of a clock cycle.

In an exemplary embodiment of a switching signal general I 400 depicted by FIG. 2b, V_{QH}, V_{QL} are used in conjunction with the clock signal CLK to drive a network of logic gates U1-U7 to provide switching control signals Q4G, Q5G, Q6G, Q7G, and Q8G to actuate switching elements Q4, Q5, Q6, Q7, and Q8 of a switching and regulation circuit 600 in FIG. 3. In an exemplary embodiment of switching signal general II 500 depicted by FIG. 2c, the clock signal CLK is used in conjunction with V_{QBH} to drive a network of logic gates U8-U10 and controlled passing elements 510 and 520 to produce switching control signals Q1G and Q3G to actuate switching elements Q1 and Q3, and switching and regulation control signal REG to enable or disable a voltage regulation circuit 505 of a switching and regulation circuit 600 in FIG. 3. Table 1 below shows the logic levels of Q1G, Q3G, Q4G, Q5G, Q6G, Q7G, Q8G, and REG during each of the three modes in both charging and transfer phases.

TABLE 1

| | | | | | | | | Switching Control Signal Logic Levels | | | | | | | |
|---|---|---|---|---|---|---|---|---|---|---|---|---|---|---|---|
| Mode | Phase | V_{CH} | V_{CL} | V_{QH} | V_{QBH} | V_{QL} | CLK | Q1G | REG | Q3G | Q4G | Q5G | Q6G | Q7G | Q8G |
| 1× | Charging | L | L | L | H | L | H | L | H | L | L | L | L | L | H |
| 1× | Transfer | L | L | L | H | L | L | H | L | H | L | L | L | L | L |
| 1.5× | Charging | H | L | H | L | L | H | H | H | H | L | H | L | H | H |
| 1.5× | Transfer | H | L | H | L | L | L | L | L | L | H | L | H | L | H |
| 2× | Charging | H | H | H | L | H | H | H | H | H | L | L | H | L | H |
| 2× | Transfer | H | H | H | L | H | L | L | L | L | H | L | H | L | H |

In an exemplary embodiment of a switching and regulation circuit 600 depicted by FIG. 3, all switching elements Q1-Q8 are of a transistor type commonly known in the art as enhancement mode N channel MOSFET. The state, or configuration, of a typical enhancement mode N channel MOSFET, either open or close, is controlled by the logic voltage level applied to its gate terminal. The typical enhancement mode N channel MOSFET is at open or off state when a logic low voltage of value L applied to its gate terminal, and is at close or open state when a logic high voltage of value H applied to its gate terminal. In the switching and regulation circuit 600, the configurations of switching elements Q1-Q8 are controlled by Q1G, REG, and Q2G-Q8G, respectively. Table 2 below shows the configurations of the switching elements Q1-Q8 during each of the three modes in both charging and transfer phases. The switching element Q2 is not actuated directly by signal REG, rather, it is used as both a switching element and an output voltage regulation pass transistor as explained in detail below.

TABLE 2

| | | Switching Element Configurations | | | | | | | |
|---|---|---|---|---|---|---|---|---|---|
| Mode | Phase | Q1 | Q2 | Q3 | Q4 | Q5 | Q6 | Q7 | Q8 |
| 1× | Charging | open | close | open | open | open | open | open | close |
| 1× | Transfer | close | open | close | open | open | open | open | open |
| 1.5× | Charging | close | close | close | open | close | open | close | close |
| 1.5× | Transfer | open | open | open | close | open | close | open | close |
| 2× | Charging | close | close | close | open | open | close | open | close |
| 2× | Transfer | open | open | open | close | open | close | open | close |

The regulated output of the inductor-less DC/DC regulator 100, V_{OUT}, is regulated as shown in an exemplary embodiment of a voltage regulator circuit 605 of the switching and regulation circuit 600 in FIG. 3. The V_{OUT} is first divided down by a resistor divider comprises resisters 630 and 640, with resistance values of R4 and R5, respectively. The after division voltage, V_{OUTF}, with a value of V_{OUT}×R5/(R4+R5), is then fed back to the inverting input of an error amplifier 610. R4 and R5 are chosen in such a way that when V_{OUT} reaches the desired output voltage level, V_{OUTF} is equal to the output voltage of the bandgap voltage reference 190, V_{VRL}. During a transfer phase under any operation mode, the REG is always at logic low, which disables the error amplifier 610 and forces a logic low output on the output of the error amplifier 610 to keep the switching and regulation element 620 at open or off state. During a charging phase, the REG is always at logic high to enable the error amplifier 610. The error amplifier 610 amplifies the voltage differential between V_{OUTF} and V_{VRL}. Its output drives the gate of the switching and passing element 620 to adjust the charging current coming into flying capacitors 810 and 820 during 1.5× and 2× modes, or 810 during 1× mode. The output voltage V_{OUT} is thus regulated to the desired voltage level.

I claim:

1. A multi-mode multi-phase inductor-less DC/DC regulator, comprising:
a) an input, connected to a voltage source;
b) a resistor divider array;
c) a voltage reference array;
d) a switching control circuit;
e) a switching and regulation circuit, and
f) an output, connected to a load.

2. The multi-mode, multi-phase inductor-less DC/DC regulator of claim 1, wherein at least some elements constituting said multi-mode, multi-phase inductor-less DC/DC regulator, not including said capacitors, are implemented in a single semiconductor device.

3. The multi-mode multi-phase inductor-less DC/DC regulator of claim 1, wherein said resistor divider array comprises no more than three resistors, produces no more than two output voltages to said switching control circuit to initiate mode selection and automatic mode switching among at least two different operation modes.

4. The multi-mode multi-phase inductor-less DC/DC regulator of claim 1, wherein said voltage reference array comprises no more than two voltage references, produces no more than two constant output voltages to said switching control circuit to assist initiate selection and switching among at least two different operation modes.

5. The multi-mode multi-phase inductor-less DC/DC regulator of claim 1, wherein said switching control circuit comprises:
a) no more than two comparators;
b) no more than two latching devices;
c) a clock source;
d) a plurality of logic gates, and
e) no more than two controlled passing elements.

6. The multi-mode multi-phase inductor-less DC/DC regulator of claim 5, wherein said no more than two comparators compare output voltages from said resistor divider array and constant output voltages from said voltage reference array to select the operation mode for said multi-mode multi-phase inductor-less DC/DC regulator from at least two different operation modes.

7. The multi-mode multi-phase inductor-less DC/DC regulator of claim 5, wherein said no more than two latching devices, said clock source, said plurality of logic gates and said no more than two controlled passing element produce switching and regulation control signals to control said switching and regulation circuit.

8. The multi-mode multi-phase inductor-less DC/DC regulator of claim 1, wherein said switching and regulation circuit comprises:
a) no more than eight switching and regulation elements;
b) no more than two capacitors, and
c) a voltage regulation circuit.

9. The multi-mode multi-phase inductor-less DC/DC regulator of claim 8, wherein said switching and regulation circuit processes switching and regulation control signals from said switching control circuit, actuates some or all of said no more than eight switching and regulation elements to select from and switch between at least two different operation modes, each comprises at least two different phases, and to enable and disable said voltage regulation circuit.

10. The multi-mode multi-phase inductor-less DC/DC regulator of claim 8, wherein said switching and regulation circuit processes switching and regulation control signals from said switching control circuit, actuates some or all of said no more than eight switching and regulation elements to configure said no more than two capacitors to one of at least two different phases during one of at least two different operation modes.

11. The multi-mode multi-phase inductor-less DC/DC regulator of claim 8, wherein said switching and regulation circuit processes feedback from said output to allow said voltage regulation circuit to provide a regulated voltage to a load.

12. The multi-mode multi-phase inductor-less DC/DC regulator of claim 11, wherein said voltage regulation circuit comprises:
a) a voltage divider including two resistors;
b) an error amplifier;
c) a switching and regulation element.

13. The multi-mode multi-phase inductor-less DC/DC regulator of claim 12, wherein said voltage divider divides said output to produce a voltage to control said voltage regulation circuit.

14. The multi-mode multi-phase inductor-less DC/DC regulator of claim 12, wherein said error amplifier amplifies the input voltage differential between the voltage produced by said voltage divider and one voltage from said voltage reference array to adjust the gate bias voltage of said switching and regulation element to control the current passing through said switching and regulation element to regulate said output of said multi-mode multi-phase inductor-less DC/DC regulator.
